(19) United States
(12) Patent Application Publication
(10) Pub. No.: US 2026/0079975 A1
(43) Pub. Date: Mar. 19, 2026

(54) AUTOMATED ARTIFICIAL INTELLIGENCE DATASET CREATION AND EVALUATION

(71) Applicant: Salesforce, Inc., San Francisco, CA (US)

(72) Inventors: Manjeet SINGH, San Francisco, CA (US); Deepak MUKUNTHU, Bellevue, WA (US); Sitaram ASUR, San Francisco, CA (US); Bin BI, Bellevue, WA (US); Roshanak OMRANI, San Francisco, CA (US); Andrew S. BANKS, San Francisco, CA (US)

(73) Assignee: Salesforce, Inc., San Francisco, CA (US)

(21) Appl. No.: 19/022,316

(22) Filed: Jan. 15, 2025

Related U.S. Application Data
(60) Provisional application No. 63/695,255, filed on Sep. 16, 2024.

(51) Int. Cl. G06F 16/334; G06F 16/353

(52) U.S. Cl. CPC G06F 16/334; G06F 16/353

(57) ABSTRACT

Disclosed herein are systems and methods for generating custom datasets. For example, a method may include using one or more computer systems to gather a first dataset comprising example data relevant to a use case. The method may also include using a first artificial intelligence (AI) model implemented by the one or more computer systems to generate a second dataset. Input to the first AI model includes at least a portion of the first dataset. The method may also include configuring a second AI model using the second dataset. The gathering, generating, and configuring may occur within an integrated platform.

### CROSS REFERENCE TO RELATED APPLICATION

The present application claims the benefit of U.S. Provisional Application No. 63/695,255 filed on Sep. 16, 2024, and entitled “Automated Artificial Intelligence Dataset Creation and Evaluation”, which is herein incorporated by reference.

### BACKGROUND

Generative artificial intelligence models require high quality, domain specific data to learn effectively. However, ready to use, domain specific datasets are often unavailable. Such datasets are often compiled, labeled, and/or annotated manually. This is time consuming, costly, and often outsourced to third parties.

### BRIEF DESCRIPTION OF THE DRAWINGS/FIGURES

The accompanying drawings are incorporated herein and form a part of the specification.

The following figures use like reference numbers to refer to like elements. Although the following figures depict various example implementations, alternative implementations are within the spirit and scope of the appended claims. In the drawings:

FIG. 1 shows an example environment, according to some aspects.

FIG. 2 shows an example integrated system, according to some aspects.

FIG. 3 shows a process for creating a custom dataset, according to some aspects.

FIG. 4 shows a process for training an artificial intelligence model using a custom dataset, according to some aspects.

FIG. 5 shows a computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, method, and/or computer program aspects, and/or combinations and sub-combinations thereof, for generating custom datasets in an integrated platform. The custom data sets may be used to train, test, benchmark and evaluate artificial intelligence models. Furthermore, the systems and methods described herein may allow a non-technical user to create or customize a large language model (LLM).

Many different business computer environments, and in particular those that serve customer or subscriber needs, may include one or more AI models that can be used by customers to carry out various tasks. For example, a customer sales environment may be used by subscribers to track sales team statistics, as well as account information of their customers. Such account information may include information relating to a sales individual or sales team, including volume or dollars sold, number of accounts being handled, and customer business and contact information, and sales targets. Meanwhile, the account information may further include information relating to the different accounts, such as customer business information, primary contacts, pending accounts, account targets etc. In such an environment, machine learning models may be made available to the subscribers in order to assist them with their various business tasks. In aspects, such tasks may include a wide range of requests, from something as fundamental as making a request for information (e.g., “what is the contact information of the primary point of contact at Company A?”) to something that far more complex (e.g., “For all accounts currently assigned to Salesperson A, generate a spreadsheet showing percentages of sales to those accounts over the various products purchased by those accounts.”).

Developers, and in some instances, customers, may need to tailor the one or more AI models to perform business related applications. For example, a developer may use custom datasets to train elements of a large language model (LLM) to retrieve and summarize business data from a customer database. Custom datasets may also be used to test and evaluate chatbots, test and evaluate prompt templates for LLMs, and evaluate toxicity, bias and safety of an LLM response.

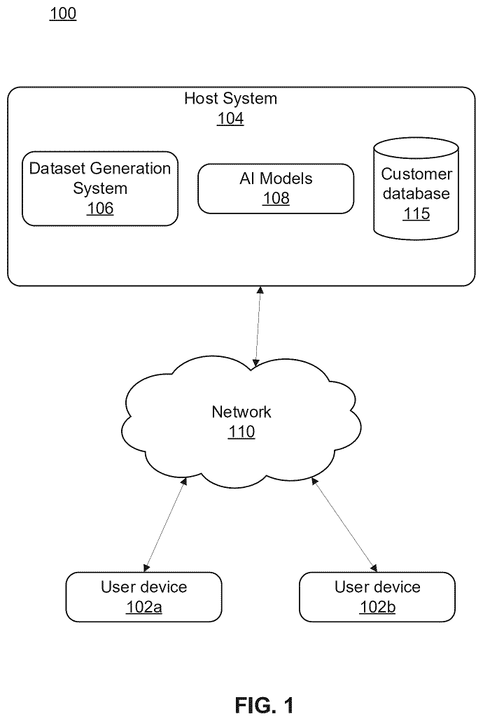

FIG. 1 shows a block diagram of example environment 100 in which example systems and/or methods may be implemented. Environment 100 may include user devices 102a and 102b, which may take the form of a mobile device, a personal computer, or other electronics capable of communicating over a network, such as a smartphone, tablet, computer, personal digital assistant, smart watch, or the like. The environment may also include a host system 104. In some aspects, host system 104 may include all interfaces and functionality in support of a subscriber, as well as internal systems. Included within host system 104 are a dataset creation module 106 and one or more AI models 108.

As shown in FIG. 1, user devices 102a and 102b may connect to the host system 104, dataset generation system 106, and one or more AI models 108 over a network 110. In some aspects, network 110 may comprise any type of computer or telecommunications network capable of communicating data, including but not limited to a local area network, a wide-area network (e.g., the Internet), or any combination thereof. The network may include wired and/or wireless segments. In some aspects, network 110 may be a secure network. In some aspects, one or more of user devices 102a and 102b may reside within network 110.

Host system 104 may have access to a plurality of databases or libraries, including a database 115. Database 115 may comprise a multi-tenant database which holds customer data for multiple subscribers. The customer data may relate to a specific company (subscriber) accessing the service, its employees, or business accounts associated with the company or its employees, such as one or more sales accounts. Database 115 may have built in functionalities that allow subscribers to access only their own data. Database 115 may be located within the host system, separate from the host system but still local, or accessible by the host system via network 110.

During operation, a user of user device 102a or 102b may access dataset creation module 106 and one or more AI models 108 via network 110. The user may generate a custom dataset using one or more applications contained with dataset generation system 106. The user may additionally train, test, benchmark, or otherwise evaluate the one or more AI models 108 using the custom dataset.

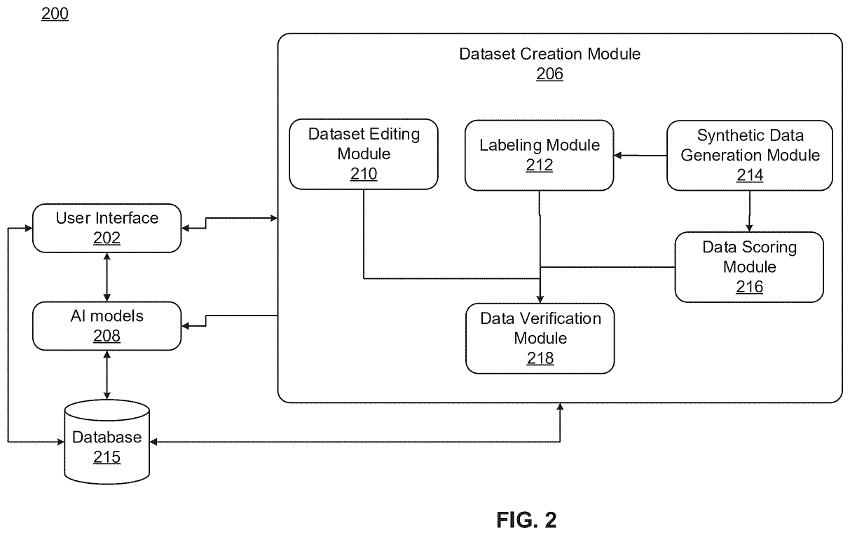

FIG. 2 shows a block diagram of a system 200, according to some aspects. System 200 may comprise a plurality of software applications that a user accesses via an integrated platform. The plurality of software applications may include cloud-based applications and/or enterprise applications hosted at a customer location. The integrated platform may provide infrastructure to connect and integrate the plurality of software applications. For example, the integrated platform may include a core integration engine, connectors, and adapters. Connecting the plurality of software applications via the integrated platform allows a non-technical user to perform complex custom data operations via a single user interface.

For example, an integrated platform may contain artificial intelligence (AI) models, a testing software used to test and evaluate the AI models, and a synthetic data generation service that generates the data needed for comprehensive testing. If a user wishes to test or fine-tune one of the AI models, the user may access a testing module via a dashboard on a user interface. There, the user may choose which AI model to test and a dataset for testing the model. If a dataset is not available, the user may input a prompt to generate a synthetic dataset, and choose evaluation metrics for the synthetic dataset.

In the example shown in FIG. 2, system 200 includes a user interface 202, a dataset generation module 206, a database 215 and one or more artificial intelligence (AI) models 208.

A user may access system 200 through user interface 202. User interface 202 may encompass buttons, text, images, sliders, text entry fields, and other similar components. In some embodiments, user interface 202 contains a dashboard that allows a user to view, configure and perform operations on datasets.

Dataset creation module 206 may include several software applications that allow a user to create a custom dataset. For example, dataset creation module 206 may contain a dataset editing module 210, a labeling module 212, a synthetic data generation module 214, a scoring module 216, and a verification module 218.

Dataset editing module 210 may comprise a set of data cleaning and processing tools that allow a user to quickly clean, segment, pre-process, or otherwise edit a dataset. For example, dataset editing module 210 may include software that allows a user to visualize and modify data. Additional software in data editing module 210 may identify and correct errors in a dataset automatically. A user may provide instructions to dataset editing module 210 through user interface 202.

Labeling module 212 may comprise an artificial intelligence (AI) model. The AI model may be configured to automatically label data. For example, the AI model may automatically label data based on a labeling function provided by the user via user interface 202. The labeling function may contain a set of rules or instructions for labeling the dataset. In an additional embodiment, the AI model may automatically suggest labels for the data based on patterns and correlations in existing labeled data.

In some embodiments, labeling module 212 may incorporate user feedback. For example, labeling module 212 may display example labels to a user via user interface 202. The user may review and/or correct the example labels. Labeling module 212 may use the user feedback to improve the machine-learning model.

Synthetic data generation module 214 may comprise a generative artificial intelligence (AI) model. The generative AI model may be fine-tuned to generate example language-based datasets covering a diversity of use cases, languages, and/or industries. The generated data may vary in complexity, ranging from simple fact retrieval to complex reasoning and multi-step problem solving. The generated data may have a similar style to customer data stored in customer database 112.

Table 1 shows possible use cases and formats for data generated by synthetic data generation module 214. Table 1 also shows an approximate number of data records commonly generated for each use case.

TABLE 1

| | | # |
|---|---|---|
| Use Case | Data Format | Records |
| Text | Text data labeled with specific categories (e.g., | 1,000 |
| classification | topics, genres) | |
| Multi-label | Textual data categorized into predefined classes | 1,000 |
| Classification | or categories | |
| Text | Paired documents (e.g., original documents and | 500 |
| Summarization | concise summaries) | |
| Chatbots | Dialogue pairs (e.g., prompt and response) | 1,000 |
| Question | Question-Answer-Evidence triplets | 1,000 |
| Answering | | |
| Code | Paired natural language descriptions and | 50,000 |
| Generation | corresponding code snippets | |
| Email Writing | Examples of emails categorized by purpose | 20,000 |
| | (e.g., complaint, inquiry, sales pitch) | |
| Sentiment | Text snippets labeled with positive, negative, or | 1,000 |
| Analysis | neutral sentiment | |
| Translation | Pairs of sentences in source and target language | 5,000 |
| Text to SQL | Natural language query- SQL pairs | 5,000 |
| RAG | Query, positive texts list, negative texts list | 500 |

Inputs to synthetic generation module 214 may include a prompt and example data records. Synthetic generation module 214 may receive the prompt from a user via user interface 202. The prompt may specify dataset generation parameters. For example, the prompt may specify the total number of records to generate, the types of industries the data should span, complexity of the data, and/or languages contained in the data. The example records input into synthetic generation module 214 may include about 3-10 example data records for each use case.

In one embodiment, synthetic generation module 214 may generate a synthetic dataset for tuning a retrieval augmented generation (RAG) functionality of a LLM to retrieve and summarize knowledge from a customer database, such as database 215. Here, the prompt may specify business use cases, such as sales, marketing, field service, etc. The prompt may also specify languages (e.g., English) and industries (e.g., banking, finance, technology, and healthcare). Additionally, the prompt may specify the preferred complexity of the synthetic data. For example, complexity may range from simple fact retrieval to complex reasoning and multi-step problem solving. Example data records, which are included with the prompt, may include input queries (i.e., natural language questions posed by users), indexed data entries (that the RAG retrieves information from, e.g., entries of database 215), and generated responses (similar to those that should be produced by the RAG). The example data records may span multiple use cases, including customer inquiries, internal database searching, and multi-step problem solving.

Synthetic data generation module 214 may generate hundreds or thousands of data records based on the prompt and example data records. The diversity of data generated by synthetic generation model 214 may depend on both in the diversity of the example data records, and on a set generation temperature of the generative AI model. The user may set the generation temperature of the generative AI model to achieve a desired dataset diversity.

In one example, a synthetic dataset may be created for evaluating a generative AI system. The synthetic dataset may contain synthetic inputs (e.g., a question), synthetic intermediates (e.g., agent steps, relevant docs), and a synthetic output (e.g., answer to the question). During testing, the synthetic inputs may be feed to the generative AI system. Then, the actual intermediates and output are compared to the synthetic intermediates and synthetic outputs to evaluate the system.

Data scoring module 216 may be configured to score datasets. For example, data scoring module 216 may score datasets received from synthetic generation module 214. Scoring can quickly inform a user if a synthetic dataset meets certain quality metrics. For example, synthetic datasets may be scored on diversity, accuracy, semantic coherence, acceptance rate, Fl score, factual knowledge, or the like. In some embodiments, a user may choose which metrics to score. User interface 202 may display a dashboard containing diversity scores and calculated data quality metrics output by data scoring module 216. If a synthetic dataset scores poorly on one or more metrics, a user can revise the input to the synthetic generation module 214 (i.e., prompt and example data records) to generate a new synthetic dataset.

Data verification module 218 may perform security checks on datasets created at data cleaning module 210, data labeling module 212 and/or data generation module 214. For example, data verification module 218 may ensure that datasets cleaned and/or labeled by data cleaning module 210 and data labeling module 212 do not contain personal identifiable information (PII). When synthetic data is generated by synthetic generation module 214, verification module 218 may ensure that the synthetic dataset does not contain toxic language, does not contain copyrighted material, and/or is in a preferred format. In some embodiments, at least a portion of generated datasets may be manually validated by a user.

Data labeled, generated, scored, and/or verified in dataset generation module 206 may be utilized by other applications in system 200, such as database 215 and one or more AI models 208.

One or more AI models 208 may be trained, fine-tuned, tested, benchmarked, or otherwise evaluated using datasets created by dataset generation module 204. In some embodiments, one or more AI models 208 may include generative AI models, such as large language models (LLMs), or the like. The custom datasets may be used, as non-limiting examples, to train or fine-tune a retrieval augmented generation (RAG) functionality of an LLM, test and evaluate chatbots, test and evaluate prompt templates, and evaluate toxicity, bias, and safety of an LLM response.

Custom datasets may be used to train a LLM for specific business purposes. For example, custom datasets may train an LLM to generate sales and marketing emails, train a chatbot to interact with users in a specific market, provide chat based coding assistance, summarize calls, summarize sales and marketing data, and the like. Custom datasets may also be used by internal development teams to train text to SOQL searches, fine tune text summarization modules, and evaluate trust models (i.e., models that mask PII, etc.)

In one non-limiting example, consider a LLM that powers a tax assistant chatbot configured to generate text specific to the Indian tax market. If the LLM is not grounded in data related to the Indian tax market, the LLM may give incorrect results. To fix this issue, a retrieval model of the LLM may be fine-tuned to retrieve relevant documents. Fine-tuning the retrieval model may require a dataset comprising hundreds of query and document pairs. While a few specific examples may be automatically compiled from existing databases or the web, a user may not have enough data to fine tune the model.

To create a synthetic dataset, the user may compile a few example data records containing sample queries, relevant documents, and generated outputs. These samples may be automatically compiled by mining a database, such as database 215, or the web using a LLM. The examples may also be compiled manually by the user. The user can then develop a prompt for a synthetic data generation module (e.g., 214). The prompt may specify parameters important to the dataset. For example, language, complexity, and use cases. The user can input the prompt and example data record into a synthetic generation model to generate a large dataset. The dataset may then be used to ground the model in data relevant to the Indian tax market.

Database 215 may store datasets and metadata created by data generation module 204 . . . . In some embodiments, datasets may be stored with metadata including a dataset name, a dataset type, a dataset summary, a dataset structure, intended use of the dataset, language, and considerations for using the data. This may allow a user to easily search for and reuse a dataset.

Database 215 may also contain customer data, as described above in reference to database 115 in FIG. 1. Customer data stored in database 215 may be used by data creation module 210, labeling module 212, or synthetic data module 214. In some embodiments, a user may automatically mine database 215 to gather example data records for generating synthetic data. As described above, database 215 may be configured such that users may only access their own data.

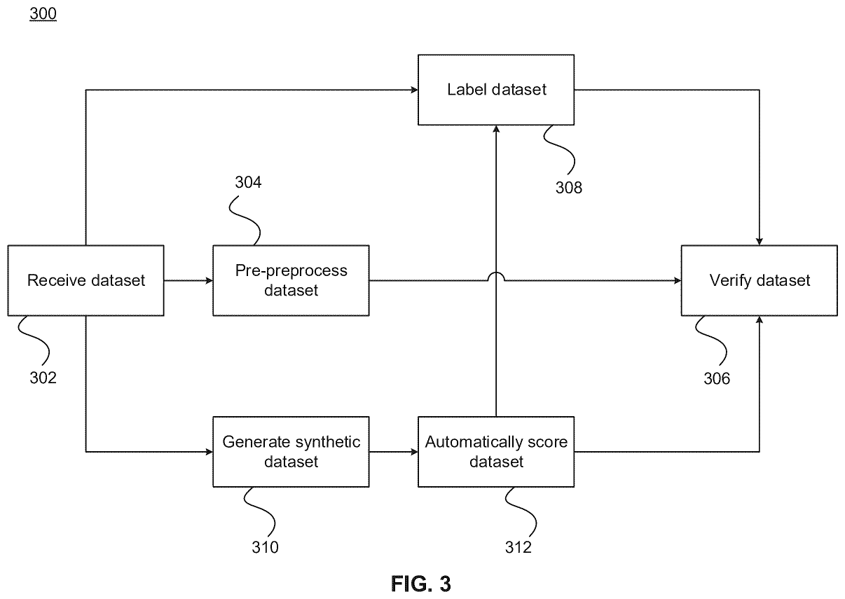

FIG. 3 shows an example process 300 for creating custom datasets. Process 300 may be implemented by one or more applications contained within an integrated platform, as described in reference to FIG. 2. However, process 300 is not limited to this embodiment.

At 302, process 300 may include receiving a dataset sourced by a user. The dataset may be complied from publically available sources, sampled from an internal database, manually created, or the like. The dataset may be curated for a specific application, for example, fine-tuning retrieval augmented generation (RAG) for a large language model (LLM).

The amount and type of data contained in the dataset received at 302 may impact subsequent steps in method 300. In a first scenario, the dataset received at 302 contains a sufficient amount of data for a desired application and contains any necessary labels and/or annotations. Thus, at 304, process 300 may include segmenting, cleaning, and/or preprocessing the dataset. Next, at 306, process 300 may include verifying the dataset. As described above, verification may include running the dataset through trust, security, and formatting checks.

In a second scenario, the dataset received at 302 contains a sufficient number of records, but does not contain desired labels or annotations. Here, process 300 may include labeling the dataset at 308. Labeling may be performed by labeling model, such as labeling module 212. Process 300 may then return to 306, where the labeled dataset is verified.

In a third scenario, the dataset received at 302 may not contain enough data for a desired application. Here, the dataset may be augmented with synthetic data. At 310, process 300 may include generating synthetic data. The synthetic data may be created by a generative AI model, such as synthetic generation module 214. At 312, process 300 may include scoring the dataset. A data scoring application, such as data scoring module 216, may score the data using several metrics, such as dataset diversity, semantic coherence, toxicity, and the like.

If the data generated at 310 requires labels and/or annotations, process 300 can return to 308, where the dataset is labeled. Then, process 300 can return to 306, where the dataset is verified. If the dataset created at 310 does not require labeling, process 300 can return directly to 306.

In some embodiments, a user may use process 300 to create a custom dataset. The user may use the custom dataset to train or fine-tune a custom artificial intelligence model. The user may create the dataset and train/fine-tune the artificial intelligence model within an integrated platform. This allows a non-technical user to easily create a dataset and train/fine-tune a model within a single workflow.

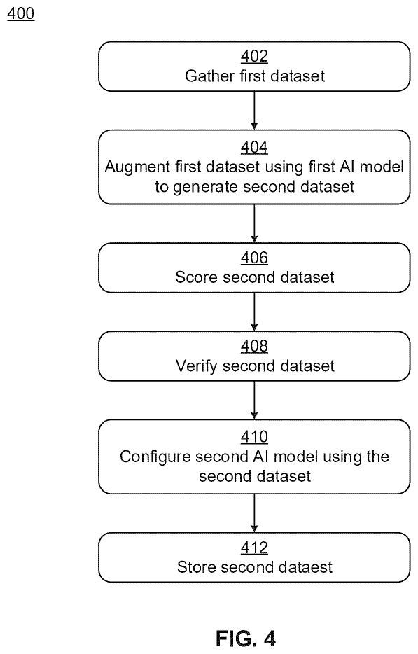

FIG. 4 shows a flow chart of an example process 400. Process 400 may describe an end-to-end workflow for configuring an artificial intelligence model using a custom dataset. It may be appreciated that not all steps of process 400 may be needed to perform the disclosure provided herein. Furthermore, some of the steps may be performed simultaneously, or in a different order than the one shown in FIG. 4, as will be understood by a person of ordinary skill in the art.

It may be appreciated that the process 400 may be implemented in an integrated platform, such as integrated platform 200. However, process 400 is not limited to this embodiment.

At 402, one or more computer systems may automatically gather a first dataset. The dataset may be gathered from a database containing company data (e.g., customer database 115), or from publically available sources (e.g., the internet). Data gathering may occur via common data collection methods, such as web scraping and database mining. In some embodiments, an artificial intelligence model may gather data from a customer database, such as database 115.

At 404, the one or more computer systems may augment the first dataset using a first artificial intelligence (AI) model. The augmenting may create a second dataset that is used in subsequent steps of method 400.

In one embodiment, the augmenting comprises automatically labeling the first dataset. Here, the first AI model may comprise a model configured to automatically label data, such as labeling module 212 described in reference to FIG. 2.

In an additional embodiment, the augmenting comprises generating synthetic data. Here, the first AI model may comprise a generative AI model, such as synthetic generation module 214 described in reference to FIG. 2. The generative AI model may generate synthetic data based on a prompt and example data. The example data may comprise at least a portion of the first dataset. The prompt may specify requirements for the synthetic data. For example, the prompt may specify the total number of records to generate, the types of industries the data should span, the complexity distribution of the data, and/or languages contained in the data. The prompt may further specify how many examples to generate for each of the above categories.

At 406, the one or more computer systems may score the second dataset. Scoring can comprise evaluating the dataset using data quality metrics. The data quality metrics used in the scoring may depend on the type of dataset generated. For example, text summarization datasets may be scored using accuracy, toxicity, and semantic coherence metrics, while classification datasets may be scored using accuracy and semantic robustness metrics. The scoring may be completed automatically, and in some aspects, may incorporate user feedback. The user feedback may indicate whether the synthetic data is accurate (e.g., right use case, right format).

At 408, the one or more computer systems can verify the second dataset. Verification may include running the dataset through trust, formatting and/or security checks. These checks may ensure that the dataset complies with security guidelines, does not contain offensive language, and does not contain private or confidential information.

At 410, the one or more computer systems may configure a second AI model using the second dataset. Configuring the second AI model may include training, fine-tuning, testing, benchmarking, or otherwise evaluating the second AI model. The second AI model may include a generative AI model, such as a large language model, or the like.

At 412, the one or more computer systems may store the second dataset in a database. The second dataset may be stored with metadata outlining, for example, the dataset type, how the dataset was acquired/created, the dataset structure, intended use of the dataset, and dataset language.

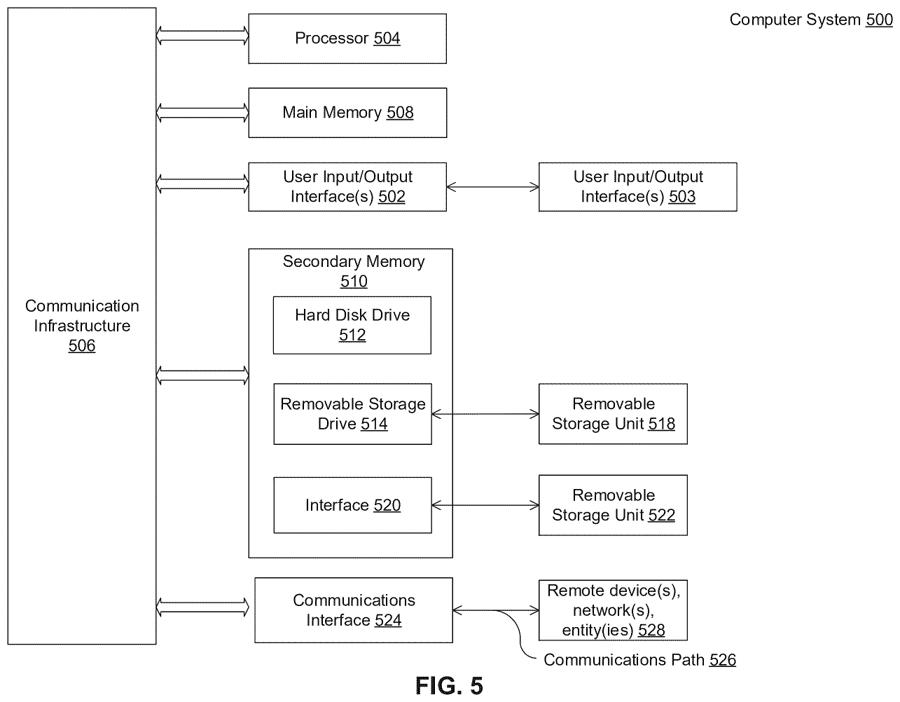

Various embodiments may be implemented, for example, using one or more well-known computer systems, such as computer system 500 shown in FIG. 5. One or more computer systems 500 may be used, for example, to implement any of the embodiments discussed herein, as well and combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 808, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method, comprising:
querying, by one or more computing devices, a first artificial intelligence (AI) model with a prompt to generate a synthetic dataset, wherein the prompt specifies synthetic dataset parameters and provides example data records, wherein the example data records are formatted for configuring a second AI model; and
configuring, by the one or more computing devices, the second AI model using the dataset, wherein the second AI model is configured to interact with customer data stored in a database.

2. The method of claim 1, further comprising automatically labeling, by the one or more computing devices, the dataset using a third AI model.

3. The method of claim 1, wherein the example data records provide examples spanning multiple industries and use cases.

4. The method of claim 1, further comprising mining, by the one or more computing devices, the database to gather the example data records.

5. The method of claim 1, wherein the synthetic dataset parameters include an amount of data and a complexity of data in the dataset.

6. The method of claim 1, further comprising verifying, by the one or more computing devices, the dataset to ensure that the dataset does not contain toxic language or copyrighted information.

7. The method of claim 1, further comprising scoring, by the one or more computing devices, the dataset using data quality metrics to determine if synthetic data in the dataset is usable.

8. A system comprising:
a memory; and
a processor coupled to the memory an configured to perform operations comprising:
querying, by one or more computing devices, a first artificial intelligence (AI) model with a prompt to generate a synthetic dataset, wherein the prompt specifies synthetic dataset parameters and provides example data records, wherein the example data records are formatted for configuring a second AI model; and
configuring, by the one or more computing devices, the second AI model using the dataset, wherein the second AI model is configured to interact with customer data stored in a database.

9. The system of claim 8, the operations further comprising automatically labeling, by the one or more computing devices, the dataset using a third AI model.

10. The system of claim 8, wherein the example data records provide examples spanning multiple industries and use cases.

11. The system of claim 8, the operations further comprising mining the database to gather the example data records.

12. The system of claim 8, wherein the synthetic dataset parameters include an amount of data and complexity of data contained in the dataset.

13. The system of claim 8, wherein the operations further comprise verifying the dataset to ensure that the dataset does not contain toxic language or copyrighted information.

14. The system of claim 8, wherein the operations further comprise scoring the dataset using data quality metrics to determine if synthetic data in the dataset is usable.

15. A non-transitory machine-readable storage medium that provides instructions that, if executed by a set of one or more processors, are configurable to cause said set of one or more processors to perform operations, the operations comprising:
querying a first artificial intelligence (AI) model with a prompt to generate a synthetic dataset, wherein the prompt specifies synthetic dataset parameters and provides example data records, wherein the example data records are formatted for configuring a second AI model; and
configuring the second AI model using the dataset, wherein the second AI model is configured to interact with customer data stored in a database.

16. The non-transitory machine-readable storage medium of claim 15, the operations further comprising automatically labeling the dataset using a third AI model.

17. The non-transitory machine-readable storage medium of claim 15, wherein the example data records provide examples spanning multiple industries and use cases.

18. The non-transitory machine-readable storage medium of claim 17, the operations further comprising mining the database to gather the example data records.

19. The non-transitory machine-readable storage medium of claim 17, wherein the synthetic dataset parameters include an amount of data and complexity of data contained in the dataset.

20. The non-transitory machine-readable storage medium of claim 15, the operations further comprising:
scoring the dataset using data quality metrics to determine if synthetic data in the dataset is usable; and
verifying the dataset to ensure that the dataset does not contain toxic language or copyrighted information.
